(19) United States
(12) Patent Application Publication
(10) Pub. No.: US 2009/0164940 A1
(43) Pub. Date: Jun. 25, 2009

(54) CUSTOMER INTERACTION RECAPTURE SYSTEM

(75) Inventor: Chris Wampler, Agoura Hills, CA (US)

Correspondence Address: Arent Fox LLP, 555 West Fifth Street, 48th Floor, Los Angeles, CA, 90013, US

(73) Assignee: Upsellit.com, Inc.

(21) Appl. No.: 11/961,906

(22) Filed: Dec. 20, 2007

(51) Int. Cl. G06F 3/048

(52) U.S. Cl. 715/808

(57) ABSTRACT

The customer interaction recapture system described herein allows for sites to interact with and offer last minute information and incentives to users exiting a website. It is desirable to have the visitor complete a particular process predefined by the website, such as filling out a signup page (registration for a particular purpose such as a mailing list), completing an order (purchase of a product or service) or providing information (used for lead-generation). In one exemplary approach, a chat service is used to prevent the abandonment of these processes by visitors. Client-side as well as back-end server-side code are used to integrate and deploy the hosted chat service on a website pages. In another exemplary approach, the chat service is used to interact with the user upon the completion of a process.

### BACKGROUND

1. Field

The present disclosed embodiments relates generally to retaining customer interaction, and more specifically to a customer interaction recapture system.

2. Background

In e-commerce, it is often a goal to have visitors complete a desired process, such as filling out a sign-up page (i.e., finish a sign-up) or a lead-generation page (i.e., provide information to be used for marketing purposes), or completing an order (i.e., complete the purchase of a product or service). However, many times customers will abandon the interaction for various reasons, such as feeling a lack of incentive to purchase a particular product or service, or not having been provided enough motivation to complete a particular sign-up or to provide information.

There is therefore a need in the art for recapturing customer interaction with a particular website that addresses the issues stated above.

### SUMMARY

To recapture customer interaction with a particular website, or to avoid the exit from the website or abandonment of an e-commerce transaction by a customer, client-side code as well as back-end server-side code are deployed to integrate and implement a hosted chat system in a customer-interaction recapture process on the website's pages. In one approach, the customer interaction recapture system is embodied in a method for customer recapture. The method includes deploying a customer recapture code at least one potential point of exit on a website; detecting an attempt to exit the website; and, deploying a chat window upon detecting the attempt to exit the website.

In another approach, the customer interaction recapture system is embodied as a computer readable media containing instructions stored thereon to cause a computer to implement a method for customer recapture, the method including deploying a customer recapture code at least one potential point of exit on a website; detecting an attempt to exit the website; and, deploying a chat window upon detecting the attempt to exit the website.

In yet another approach, the customer interaction recapture system is embodied in an apparatus having means for detecting an attempt to exit a website; and means for deploying a chat window upon detecting the attempt to exit the website.

In still yet another approach, the customer interaction recapture system is embodied in a method for maintaining customer interaction with a website. The method including determining whether a process on a website is completed successfully; and, deploying a chat window upon determination of the completion of the process.

In still yet another approach, the customer interaction recapture system is embodied in a computer readable media having computer executable code contained thereon embodying a method for maintaining customer interaction with a website, the method including determining whether a process on a website is completed successfully; and, deploying a chat window upon determination of the completion of the process.

### BRIEF DESCRIPTION OF THE DRAWINGS

FIG. 1 is a flow diagram illustrating an operation of a customer interaction recapture system that deploys a chat system.

FIG. 2 is a graphics user interface (GUI) of a website's home page displayed on a web browser to a user interacting with the website.

FIG. 3 is a GUI of a second web page of the website of FIG. 2 as displayed on the web browser.

FIG. 4 is a GUI of a pop-up display containing code used to monitor the interaction between the user and the website.

FIG. 5 is a GUI of a pop-up display used to maintain the interaction between the user and the website through the chat system deployed as part of the process of FIG. 1.

FIG. 6 is a GUI of a second website's home page displayed on a web browser to a user interacting with the second website.

FIG. 7 is a GUI of a second web page of the second website of FIG. 6 as displayed on the browser.

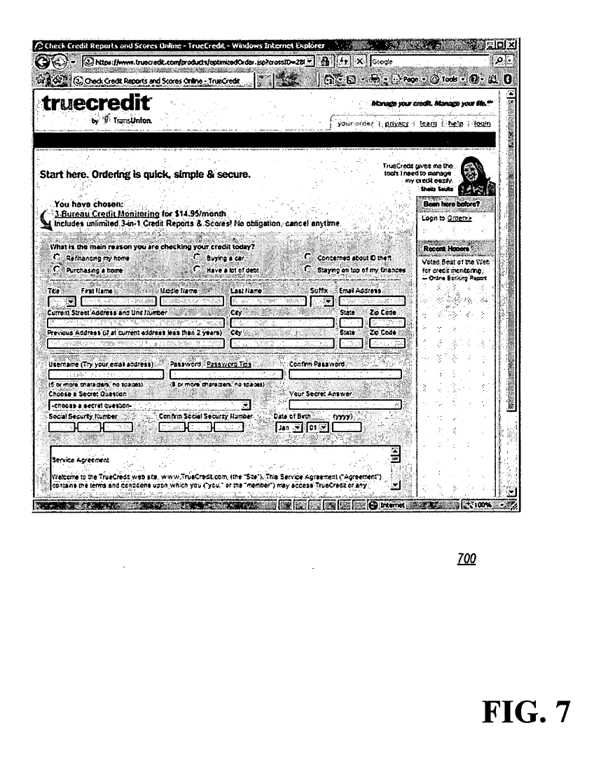

FIG. 8 is a GUI of an alert pop-up display used to inform the user that an agent wishes to talk to the user about a last-minute offer.

FIG. 9 is a GUI of a decision pop-up display used to allow the user to make a decision to maintain the interaction between the user and the second website through the chat system.

FIG. 10 is a GUI of a pop-up display used to maintain the interaction between the user and the second website through the chat system.

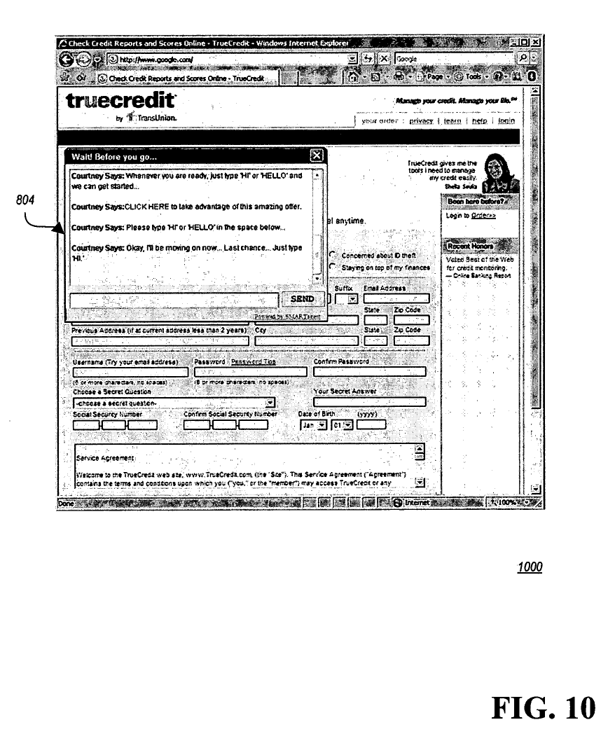

FIG. 11 is a block diagram of a computer system configured in accordance with one approach of the customer interaction recapture system.

FIG. 12 is a network diagram illustrating a network of computer systems, configured in accordance with one approach of the customer interaction recapture system.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

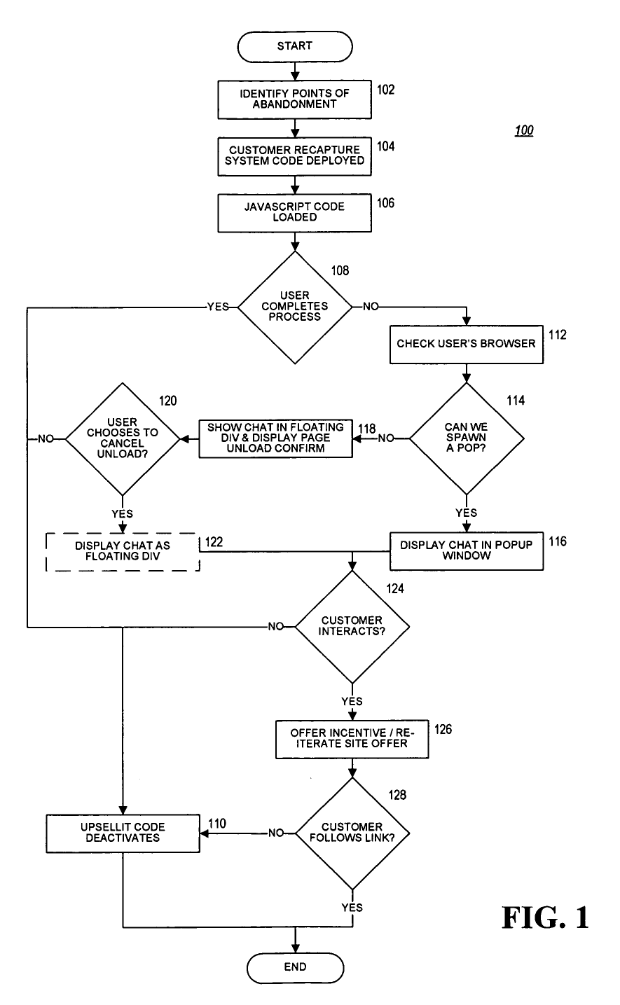

FIG. 1 is a flow diagram illustrating an exemplary process 100 for the client-side user experience on a website with exit chat code integrated that begins with step 102, where a plurality of points of abandonment is identified on a website and the customer interaction recapture system is deployed. In one approach, the plurality of points of abandonment are the web pages where customers (“users”) typically abandon an interaction with the website. In other words, the plurality of points of abandonment are the web pages where users are most likely to “exit” the website. The customer interaction recapture system is deployed by adding code to the web pages where a user may leave a website. For example, during a checkout process of e-commerce transactions, users may exit the website if they begin to feel the effects of buyer's remorse. Further, users may abandon a transaction because they are comparing prices/value propositions among various websites and feel that the prices/value proposition for the particular website in question compares unfavorably with another website. Another example is when users exit a website after they have been presented with a set of questions that they may not wish to answer, such as a lead-generation web page. Yet another example is when users exit a website once they are asked to sign-up or register for a particular marketing initiative or service.

The customer interaction recapture system described herein allows a website to interact with, and offer last minute information and incentives to, users abandoning a particular process of leaving a particular website. It is desirable to have the visitor complete a particular process predefined by a website, such as filling out a signup page (registration for a particular purpose such as a mailing list), completing an order (purchase of a product or service) or providing information (used for lead-generation). In one exemplary approach, a chat system is used to prevent the abandonment of these processes by visitors. Client-side as well as back-end server-side code are used to integrate and deploy the hosted chat system on the website's pages.

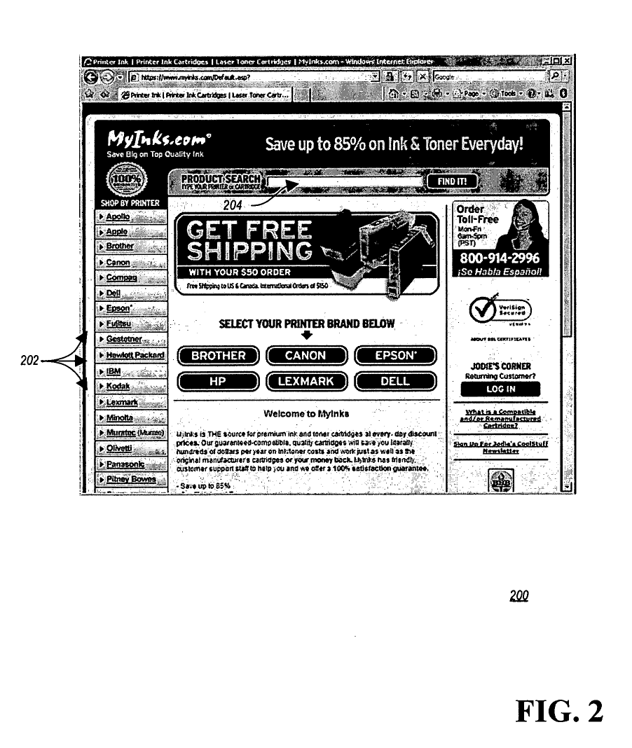

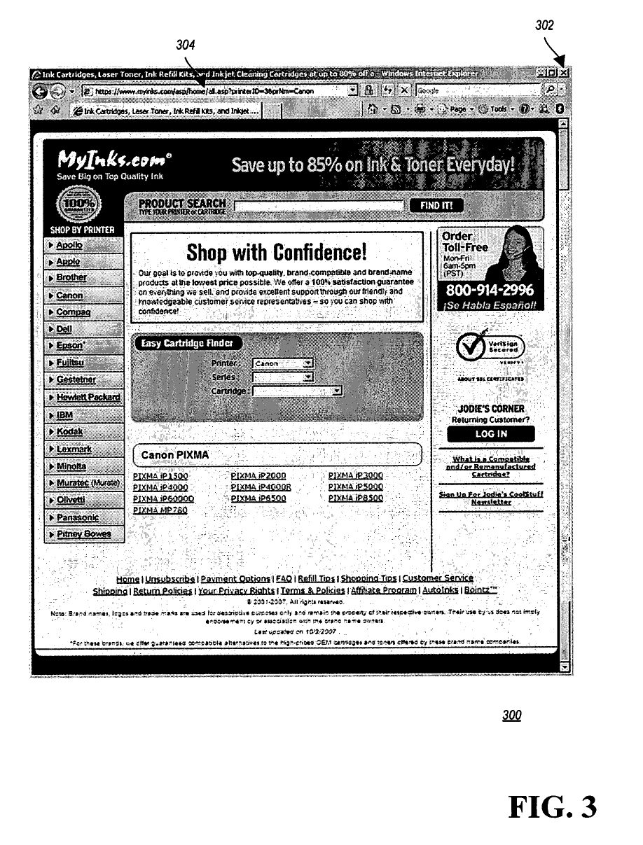

An exemplary homepage 200 for a website that sells inkjet cartridges for various brands and models of printers is shown in FIG. 2. Links 202 for the inkjet cartridges for various models of printers are sorted and grouped by brand on the home page 200. Users can also search by printer model in a search box 204. Once a user has performed a search or clicked on a link, they will be directed to a web page such as an e-commerce web page 300 as shown in FIG. 3. In one approach, a point of abandonment may be the initial webpage for the website such as homepage 200. Although the initial webpage may be a possible identified point of abandonment, it may not be an optimal choice as there may be reasons that users may wish to leave the website for which no attempt needs or should be made to try and keep the users interacting with the site. Any such attempts may be seen as intrusive and annoying to users. For example, a user may have inadvertently landed on the homepage 200 for the website, such as due to a user error in entering the universal resource locator (URL) of the intended website. In this case, no attempt should be made to keep the user interacting with the site. Another point of abandonment may be when then user reaches the e-commerce web page 300, with the idea that the user is comparing prices or other offerings between this website and another and decides that the other website has, for whatever reason, something more attractive. The user may then either close the e-commerce web page 300 by clicking on a window close button 302 or by entering a different link into an address bar 304.

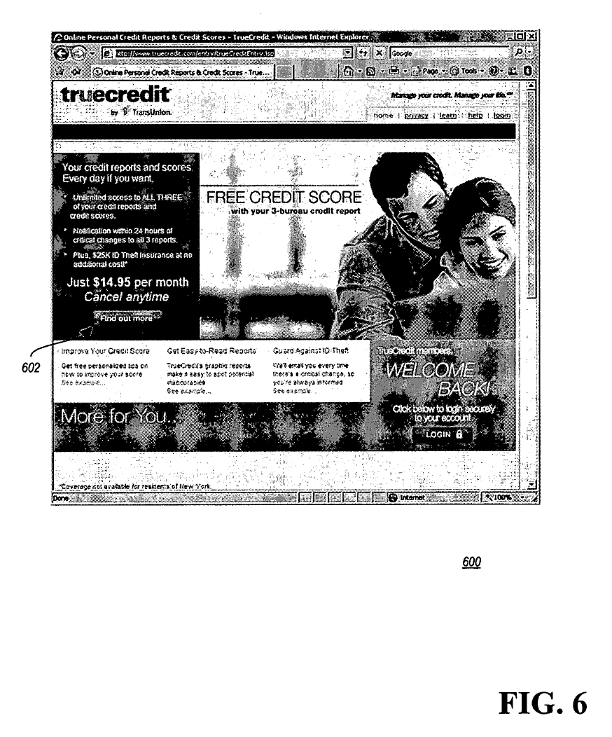

A second exemplary homepage 600 for a website that sells credit reporting service and identity theft protection is shown in FIG. 6. As seen on the second exemplary homepage 600, a sign-up link 602 is displayed that will bring the user to a sign-up web page 700 where the user can sign up for a monthly-billed credit monitoring service. Similar to the e-commerce web page 300, the sign-up web page 700 may be a point of abandonment. For example, the user may decide to abandon the sign-up process when presented with questions that are personal in nature. In another example, the user may decide to abandon the process if questions presented to the user appear to be too numerous.

Once the plurality of points of abandonment is identified, then operation continues with step 104.

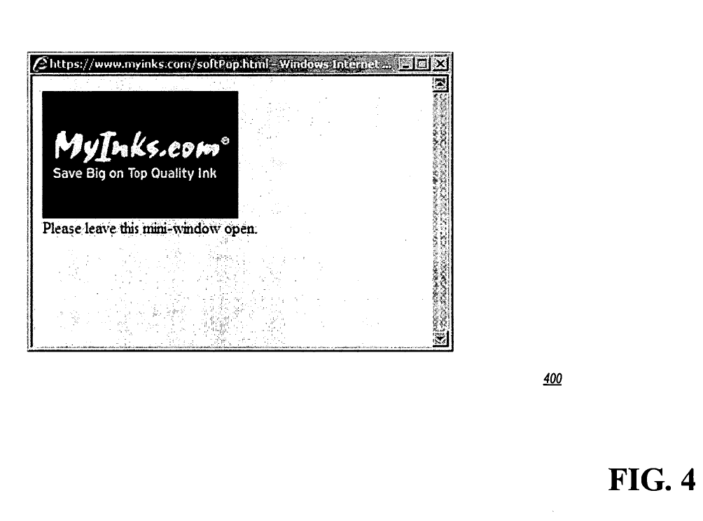

In step 104, the customer interaction recapture system code is deployed at each of the plurality of points of abandonment, where a trigger is integrated into each web page that is identified as a possible exit web page. In one approach, a JavaScript tag is provided in each of these web pages to integrate a segment of exit detection code therein. This code implements a variety of mechanisms for detecting the exit from the website, including the monitoring of user interface selections (e.g., mouse clicks) within the window of the web page to detect, for example, the closing of the window in which the web page is being displayed, the navigation away of the user from the current website (e.g., the domain or subdomain). As will further be detailed below, the trigger may be a JavaScript variable trigger that can be set by the client-side code, such as a soft-pop execution that involves the launching of a “pop-under” window to monitor the opener page's activity. FIG. 4 illustrates an exemplary pop-under window 400 that is displayed beneath the e-commerce web page 300 when the e-commerce web page 300 is first loaded.

In step 108, it is determined if the desired process has been completed. The determination of the completion of a process is dependent on the modality of the process. For example, if the process is an e-commerce transaction, the process may be completed when the user completes checkout. In another example, if the process is sign-up process, then the process is completed when the user has supplied all necessary information to sign-up. In yet another example, if the process is a lead-generation process, then the process is completed when the user has progressed through all forms that are provided to gather the lead-generation information. The abandonment may be just the exit of the user from the website. If an abandonment does not occur and the user completes the desired process, operation will continue with step 110. Otherwise, operation continues with step 112.

In step 110, the code will deactivate. In one exemplary approach, the code is deactivated so that an exit chat window is not displayed.

In step 112, if it is determined that the user is attempting to abandon the page, then the embedded JavaScript code will first retrieve information for both the server-side (HTTP header) and the client-side (JavaScript browser detection). Operation will then continue with step 114.

In step 114, the embedded JavaScript code will determine the most effective exit chat window display method for that user. The goal of this detection is to determine whether a popup window or a JavaScript confirm window requesting the user stay on the page would yield the most effective method of communicating with the user and maximizing a retained interaction rate.

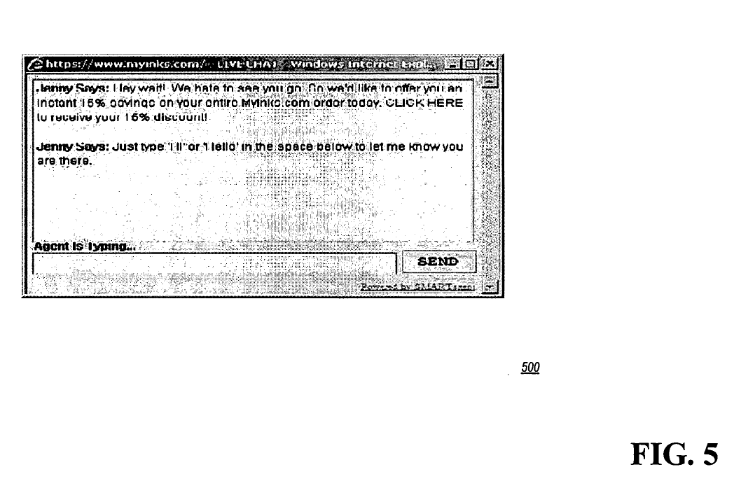

In step 116, in the case when a popup window would be the most effective, the system will automatically use that method to display a chat window. FIG. 5 illustrates an exemplary chat window 500 where a virtual chat system displays a message to the user to attempt to maintain the customer interaction.

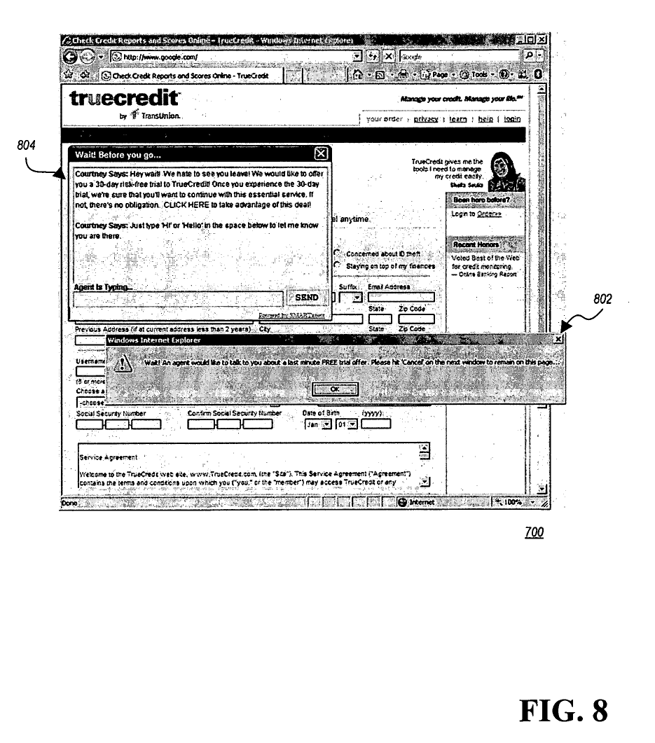

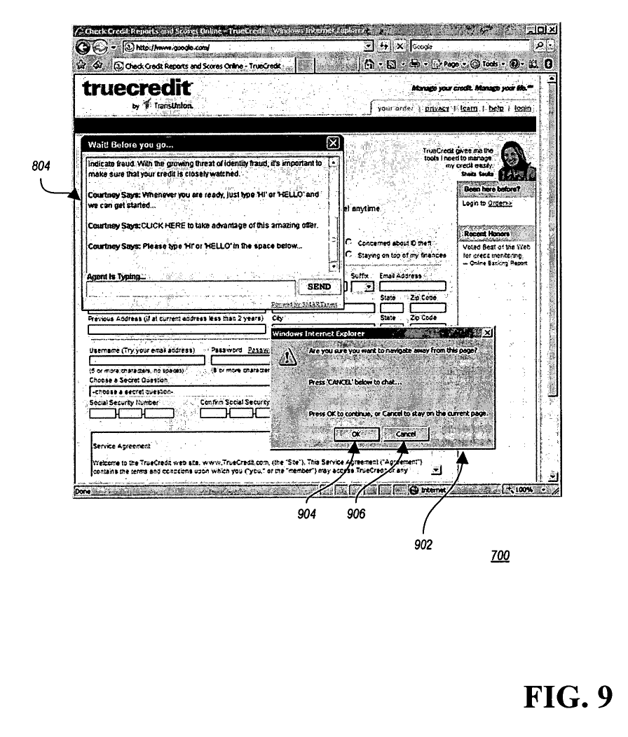

In step 118, as shown in FIG. 9, if the browser is popup prohibitive, the client will display a “confirm” panel 902 asking the user to cancel the navigation away from the site (i.e., the browser will request that the user not abandon the process—“Are you sure you want to navigate away from this page? Press ‘CANCEL’ below to chat . . . . Press OK to continue or Cancel to stay on the current page.”). In one aspect, the confirm box will contain an “OK” button 904 that will allow the user to navigate away from the page, and a “Cancel” button 906 that will “cancel” the navigation and keep the user on the page. In one aspect of the invention, referring to FIG. 8, an “alert” panel 802 is displayed before the confirm panel is displayed to alert the user that an “agent” would like to speak to them (e.g., “Wait! An agent would like talk to you about a last minute FREE trial offer. Please hit ‘Cancel’ on the next window to remain on this page . . . ”). In addition, as shown in FIG. 8, the system may simultaneously display a chat window 804 at the same time. Although the chat window 804 may be displayed later, as further discussed herein, displaying the chat window simultaneously is useful as it may entice the user to continue interacting with the site because the user can see the smart agent typing in the chat window 804.

In step 120, if the user chooses to cancel the navigation away from the page by clicking the “Cancel” button, then, in one approach, operation will continue with step 124, with the user continuing to interact with the system. In another approach, where the chat window 804 has not been previously displayed, operation will continue with step 122.

In step 122, the chat window 804 will be displayed as a floating window within the currently open page, such as the sign-up web page 700, on the client's side (i.e., the client's browser) using a <div> HTML tag. The div tag divides the content on screen using a line break above the <div> and below the </div> tag. The user will then be able to interact with the system in step 124, with the chat window 804 as a floating div within the sign-up web page 700.

In step 124, in both the floating-div confirm and the popup method, the end goal is to have the user engage the chat system so that the user may be presented with incentives or other offers and, ultimately, complete the desired transaction. If the customer continues to interact with the chat system, then operation continues with step 126.

In step 126, the message in the chat window 500 or the chat window 804 will vary greatly depending on the site, from being informational to offering an incentive. Further, a chat window allows interactivity with the client so that other information may be obtained from, or provided to, the user, such as a phone number for a customer service representative to call the user.

In step 128, during the conversation facilitated by the chat window, the end goal is to have the user follow the link provided (a link that will mark the sale/sign-up/lead as a saved visitor to the system) and drive the user back to complete the site's desired process.

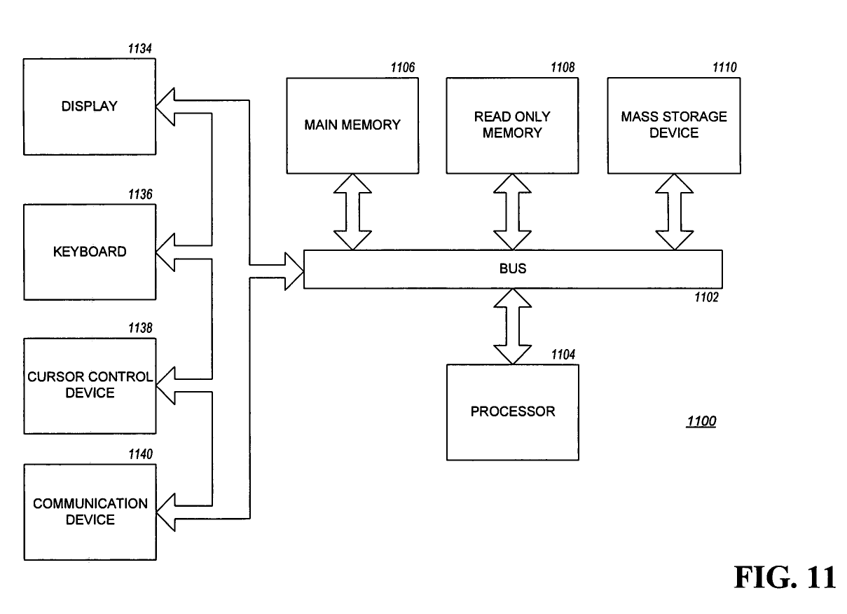

FIG. 11 illustrates an example of a computer system 1100 in which the features of the customer interaction recapture system may be implemented. Computer system 1100 includes a bus 1102 for communicating information between the components in computer system 1100, and a processor 1104 coupled with bus 1102 for executing software code, or instructions, and processing information. Computer system 1100 further comprises a main memory 1106, which may be implemented using random access memory (RAM) and/or other random memory storage device, coupled to bus 1102 for storing information and instructions to be executed by processor 1104. Main memory 1106 also may be used for storing temporary variables or other intermediate information during execution of instructions by processor 1104. Computer system 1100 also includes a read only memory (ROM) 1108 and/or other static storage device coupled to bus 1102 for storing static information and instructions for processor 1104.

Further, a mass storage device 1110, such as a magnetic disk drive and/or a optical disk drive, may be coupled to computer system 1100 for storing information and instructions. Computer system 1100 can also be coupled via bus 1102 to a display device 1134, such as a cathode ray tube (CRT) or a liquid crystal display (LCD), for displaying information to a user so that, for example, graphical or textual information may be presented to the user on display device 1134. Typically, an alphanumeric input device 1136, including alphanumeric and other keys, is coupled to bus 1102 for communicating information and/or user commands to processor 1104. Another type of user input device shown in the figure is a cursor control device 1138, such as a conventional mouse, touch mouse, trackball, track pad or other type of cursor direction key for communicating direction information and command selection to processor 1104 and for controlling movement of a cursor on display 1134. Various types of input devices, including, but not limited to, the input devices described herein unless otherwise noted, allow the user to provide command or input to computer system 1100. For example, in the various descriptions contained herein, reference may be made to a user “selecting,” “clicking,” or “inputting,” and any grammatical variations thereof, one or more items in a user interface. These should be understood to mean that the user is using one or more input devices to accomplish the input. Although not illustrated, computer system 1100 may optionally include such devices as a video camera, speakers, a sound card, or many other conventional computer peripheral options.

A communication device 1140 is also coupled to bus 1102 for accessing other computer systems, as described below. Communication device 1140 may include a modem, a network interface card, or other well-known interface devices, such as those used for interfacing with Ethernet, Token-ring, or other types of networks. In this manner, computer system 1100 may be coupled to a number of other computer systems.

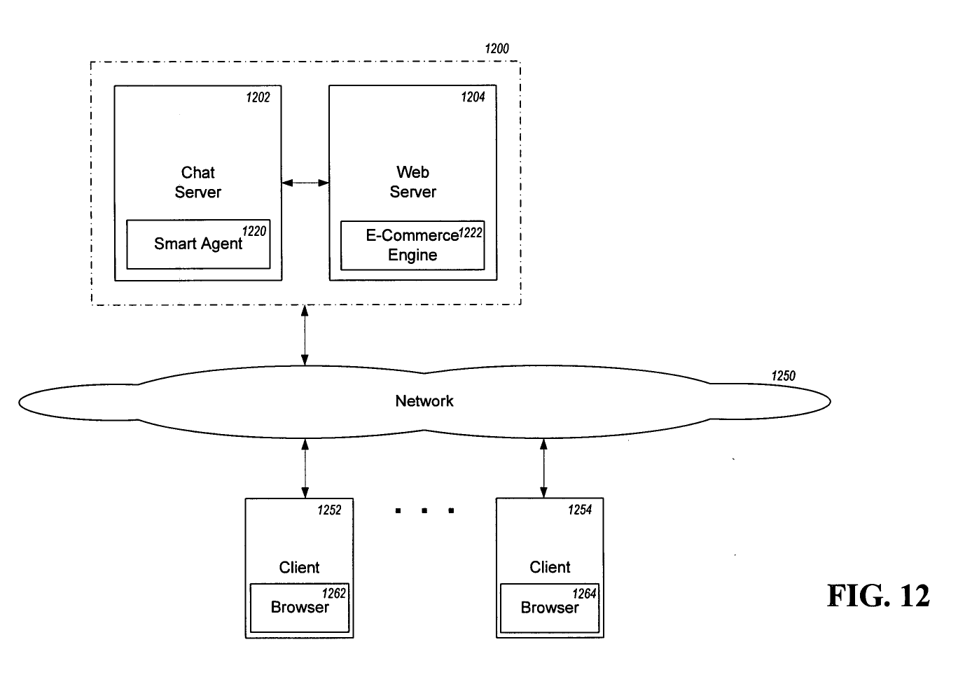

FIG. 12 illustrates a network 1200 in which the customer interaction recapture system may be implemented, including a server system 1200 having a chat server 1202 for hosting a smart agent 1220 and a web server 1204 having an e-commerce engine 1222. A client 1252 and a client 1254 are coupled for communications with the server system 1200 through a network 1250. As described herein, a user, using software on a client computer such as a browser 1262 on the client 1252 or a browser 1264 on the client 1254, interacts with the server system 1200. Multiple server systems and clients, as well as other computer systems (not shown) may also be coupled to the server system 1200. Also, the e-commerce engine 1222 interacts with other application software on the web server 1204 and the chat server 1202 to perform the customer interaction recapture system functionality as described herein, including receiving requests for web pages from client computers, generating and transmitting the necessary information for rendering the web pages on client computers (along with the client-side code that is deployed to trigger the chat window), and receiving the results therefrom. The e-commerce engine 1222 may access and present information from, as well as store information into, an e-commerce database (not shown). In certain applications where there is no e-commerce engine 1222, the web pages containing the client-side code deployed to trigger the chat window may be provided directly by the web server 1204. Further, although the server system 1200 is presented as two servers, with the web server 1204 being hosted by one entity and the chat server 1202 being hosted by yet another entity providing the customer interaction recapture system functionality, the customer interaction recapture system functionality provided herein may be deployed using a single server or may be spread over multiple systems.

In one approach, the chat session that is displayed in the chat window triggered by the web pages transmitted to the client by the webs server 1204 is hosted by the chat server 1202. Thus, as described above in the exemplary process 100 for the client-side user experience, the smart agent 1220 interacts with the user. In one approach, the smart agent 1220 is an automated chat system implemented using artificial intelligence that is able to interact with the user based on a plurality of rules based on the user's inputs. For example, the smart agent 1220 may provide responses based on detection of keywords in the responses that the user provides. In addition, the smart agent 1220 may detect whether and even how the user has interacted with the system to determine what messages to provide to the user. In one approach, the smart agent 1220 may detect how the user has interacted with e-commerce engine 1222 to determine where in the process the user had decided to abandon the interaction. For example, if the user abandoned an e-commerce transaction during a check-out process, the smart agent 1220 may offer the user a discount on shipping. In contrast, if the user abandoned the e-commerce transaction during the review of a product, the smart agent 1220 may offer the user a discount on the product or other incentive (including discounted shipping). In another example, where the user has, or is about to complete the e-commerce transaction, what the user has purchased during the e-commerce transaction may affect the operation of the smart agent 1220 so that the smart agent 1220 agent may offer additional services (e.g., offering professional installation if the user has purchased a wall-mountable flat-screen television set) or products (e.g., offering cables or other accessories for the television set).

Although the examples above are specific to e-commerce transactions such as online shopping, the scope of how the customer interaction recapture system is not limited to these examples or, as certain provided examples have detailed, even limited to the “recapture” of customer interactions. Thus, for example, the term “e-commerce” as applied in the description contained herein should be applied broadly as to any interaction with a user, whether that interaction is related to the purchasing of a product or service or a filling out of a form for information gathering purposes. The specific information, promotion or marketing response implemented by the smart agent 1220 may be customized as needed. In the illustrated embodiment, network 1250 represents a variety of networks that may include one or more local area networks as well as wide area networks. The functionality provided by the chat server 1202, the web server 1204, the client 1252 and the client 1254, as well as by any other computer systems necessary in the scalable hi-fidelity form system, may be implemented using a computer system having the characteristics of the computer system 1100 described herein. It should be noted, however, that the specific implementation of the computer system or systems used to describe the present invention is not to be limiting unless otherwise specifically noted. For example, the functionality provided by the chat server 1202 and the web server 1204 may be combined in one computer system. Further, the functionality provided by the chat server 1202 and web server 1204 may be distributed over several computer systems.

As described herein, the user may interact with the information stored in server system 1200 through browser software. The browser presents a graphical user interface (GUI) to the user. In the following description, the GUI is implemented using one or more web pages (which may be referred to as “pages,” “screens,” or “forms”) provided by web server 1204 accessible by the user using any Internet web browser software, such as the Internet Explorer™ browser provided by Microsoft Corp., on client computer such as client 1252. In another embodiment, one or more custom software programs can be created to implement the system described herein. Of course, web server 1204 may itself have browser software installed on it so as to be accessed by a user. Further, throughout the description of the various embodiments of the invention herein, references are made to the user performing such actions as selecting buttons, inputting information on forms, executing searches or updates on the smart agent 1220. In one preferred embodiment, these actions are generated by the user during the user's interaction with the browser. For example, one or more pages described herein are electronic forms that include fields in which the user may type. Once the user has provided such data, the user may select a button or link on the page to submit the information and cause an update of the smart agent 1220 with the information. The browser will send web server 1204 the information retrieved from the user using the electronic form, which will cause the smart agent 1220 to be updated.

The following description is an exemplary operation of the system where a user, using browser 1262 on client 1252, interacts with server system 1200 to request an electronic form, referred to herein as a source form. In one preferred embodiment, the request is for an individual page of an electronic form. In another preferred embodiment, the request may contain a request for multiple pages of the electronic form. Each form-page request from the client-side software (e.g., the browser) to the server application will be serviced by the server system 1200 (e.g., the e-commerce engine 1222), in accordance with the flow diagram as illustrated in FIG. 1, where, in step 102, browser 1262 sends the information needed to render the electronic form, such as: the requested page number; the width of the graphical window that is currently being displayed, referred to as the Window-Width; the level of zoom (e.g. page-width, 100%, 200%, etc.), referred to as the Zoom-Level; and if applicable, the previous page's form-data so it could be later used for possible inter-page calculation requirements or for possible committing of the form data on all pages to the smart agent 1220, as described below, to the e-commerce engine 1222.

The components, steps, features, objects, benefits and advantages that have been discussed are merely illustrative. None of them, nor the discussions relating to them, are intended to limit the scope of protection in any way. Numerous other embodiments are also contemplated, including embodiments that have fewer, additional, and/or different components, steps, features, objects, benefits and advantages. The components and steps may also be arranged and ordered differently. In short, the scope of protection is limited solely by the claims that now follow. That scope is intended to be as broad as is reasonably consistent with the language that is used in the claims and to encompass all structural and functional equivalents.

The phrase “means for” when used in a claim embraces the corresponding structure and materials that have been described and their equivalents. Similarly, the phrase “step for” when used in a claim embraces the corresponding acts that have been described and their equivalents. The absence of these phrases means that the claim is not limited to any corresponding structures, materials, or acts.

Nothing that has been stated or illustrated is intended to cause a dedication of any component, step, feature, object, benefit, advantage, or equivalent to the public, regardless of whether it is recited in the claims.

What is claimed is:

1. A method for customer recapture, comprising:
deploying a customer recapture code at least one potential point of exit on a website;
detecting an attempt to exit the website; and,
deploying a chat window upon detecting the attempt to exit the website.

2. The method of claim 1, further comprising identifying the at least one potential point of exit.

3. The method of claim 1, wherein the website is displayed in a browser window, and detecting the attempt to exit the website comprises:
creating a hidden window that is a child of the browser window; and,
monitoring the status of the browser window.

4. The method of claim 3, wherein monitoring the status of the browser window comprises detecting if the browser window is being closed.

5. The method of claim 3, wherein monitoring the status of the browser window comprises detecting if a different website is to be displayed in the browser window.

6. The method of claim 1, wherein deploying the chat window comprises:
detecting whether a pop-up window may be spawned; and,
creating a floating div window upon detecting that the pop-up window may not be spawned.

7. A computer readable media having computer executable code contained thereon embodying a method for customer recapture, the method comprising:
deploying a customer recapture code at least one potential point of exit on a website;
detecting an attempt to exit the website; and,
deploying a chat window upon detecting the attempt to exit the website.

8. The computer readable media of claim 7, wherein the method further comprising identifying the at least one potential point of exit.

9. The computer readable media of claim 7, wherein the website is displayed in a browser window, and detecting the attempt to exit the website comprises:
creating a hidden window that is a child of the browser window; and,
monitoring the status of the browser window.

10. The computer readable media of claim 9, wherein monitoring the status of the browser window comprises detecting if the browser window is being closed.

11. The computer readable media of claim 9, wherein monitoring the status of the browser window comprises detecting if a different website is to be displayed in the browser window.

12. The computer readable media of claim 7, wherein deploying the chat window comprises:
detecting whether a pop-up window may be spawned; and,
creating a floating div window upon detecting that the pop-up window may not be spawned.

13. An apparatus comprising:
means for detecting an attempt to exit a website; and,
means for deploying a chat window upon detecting the attempt to exit the website.

14. The apparatus of claim 13, wherein the website is displayed in a browser window, and the means for detecting the attempt to exit the website comprises:
means for creating a hidden window that is a child of the browser window; and,
means for monitoring the status of the browser window.

15. The apparatus of claim 14, wherein the means for monitoring the status of the browser window comprises means for detecting if the browser window is being closed.

16. The apparatus of claim 14, wherein monitoring the status of the browser window comprises detecting if a different website is to be displayed in the browser window.

17. The apparatus of claim 13, wherein the means for deploying the chat window comprises:
means for detecting whether a pop-up window may be spawned; and,
means for creating a floating div window upon detecting that the pop-up window may not be spawned.

18. A method for maintaining customer interaction with a website comprising:
determining whether a process on a website is completed successfully; and,
deploying a chat window upon determination of the completion of the process.

19. The method of claim 18, wherein deploying the chat window upon determination of the completion of the process comprises deploying the chat window upon determination that the process has not been completed.

20. The method of claim 18, wherein deploying the chat window upon determination of the completion of the process comprises deploying the chat window upon determination that the process has been completed.

21. The method of claim 18, wherein determining whether the process on the website is completed successfully comprises determining if an online order has been placed.

22. The method of claim 18, wherein determining whether the process on the website is completed successfully comprises determining if an information gathering form has been filled.

23. The method of claim 18, wherein determining whether the process on the website is completed successfully comprises determining if a user has agreed to sign-up for a service.

24. The method of claim 18, wherein determining whether the process on the website is completed successfully comprises determining if a user has agreed to purchase a product.

25. A computer readable media having computer executable code contained thereon embodying a method for maintaining customer interaction with a website, the method comprising:
determining whether a process on a website is completed successfully; and,
deploying a chat window upon determination of the completion of the process.
